(19) United States
(12) Patent Application Publication
(10) Pub. No.: US 2025/0272585 A1
(43) Pub. Date: Aug. 28, 2025

(54) TRAINING AND PERFORMING INFERENCE OPERATIONS OF MACHINE LEARNING MODELS USING SECURE MULTI-PARTY COMPUTATION

(71) Applicant: Google LLC, Mountain View, CA (US)

(72) Inventors: Gang Wang, Frederick, MD (US); Marcel M. Moti Yung, New York, NY (US)

(21) Appl. No.: 18/857,958

(22) PCT Filed: Mar. 15, 2024
(86) PCT No.: PCT/US2024/020176

§ 371 Date: Oct. 18, 2024

(30) Foreign Application Priority Data
Mar. 16, 2023 (IL) 301428

(51) Int. Cl. G06N 5/043

(52) U.S. Cl. CPC G06N 5/043

(57) ABSTRACT

This disclosure relates to a privacy preserving machine learning platform. In one aspect, a method includes identifying a request for processing an input feature vector by a machine learning model using a multiple multi-party computation (MPC) cluster including a plurality of MPC computing systems. Each feature of the input feature vector is encoded to generate an encoded weight vector. A respective share of the encoded weight vectors is generated for each computing system and provided to a corresponding computing system to generate a partial prediction for the respective share. The MPC cluster collects modified partial predictions for the input feature vector from the rest of the multiple MPC computing systems, where each of the modified partial predications is generated based on the partial prediction by a corresponding MPC computing system. A final prediction is generated by the MPC cluster based on the respective partial predictions.

### TECHNICAL FIELD

This specification relates to training and performing inference operations of a machine learning model using secure multi-party computation (MPC).

### BACKGROUND

Machine learning is a type of artificial intelligence that aims to teach computers how to learn and act without necessarily being explicitly programmed. More specifically, machine learning is an approach to data analysis that involves building and adapting models, which allow computer executable programs to “learn” through experience. Machine learning involves design of algorithms that adapt their models to improve their ability to make predictions. This is done by first training a machine learning model using historical data (training data) for which the outcome (label) is known, which is called supervised learning. The computer may identify rules or relationships during the training period and learn the learning parameters of the machine learning model. Then, using new inputs, the machine learning model can generate a prediction based on the identified rules or relationships.

Some machine learning models are trained based on data collected from multiple sources, e.g., across multiple websites and/or native applications. However, this data may include private or sensitive data that should not be shared or allowed to leak to other parties.

### SUMMARY

In general, the described techniques relate to training and performing inference operations of a machine model for preserving data privacy. In particular, the training and inference operations are performed by a system using multiple MPC computing systems (e.g., a cluster of MPC computing systems), where a particular MPC computing system of the multiple MPC computing systems in this environment accesses secret shares of data determined for the particular computing system. To improve the computation efficiency and accuracy for training and performing inference operations using the MPC computing systems, the described system implementing the described techniques includes a non-typical machine learning model (e.g., a neural network with one hidden layer for embedding input features). In addition, the client in the described system encrypts or encodes features into multiple weight vectors, generates secret shares of each weight vector, and provides respective secret shares to corresponding MPC computing systems so that different MPC computing systems receive a different secret share of each weight vector and, absent unauthorized collusion between the MPC computing systems, cannot access any weight vector in cleartext. Cleartext is text that is not computationally tagged, specially formatted, or written in code, or data, including binary files, in a form that can be viewed or used without requiring a key or other decryption device, or other decryption process.

Each MPC computing system processes its secret share of a weighting vector to determine embeddings using an embedding lookup table and deploys a respective machine learning model for processing the embedding to generate a partial prediction. Although each MPC computing system uses a respective machine learning model with substantially the same structure, the parameters of the lookup table and the machine learning models can be different across MPC computing systems. The system (e.g., a client for the inference process, a secure processor of the system, or a training subsystem for the training process) then combines the partial predictions received from multiple MPC computing systems to generate a final prediction, which could be later used for different downstream operations, e.g., determining digital content for the client for the inference process, or updating model parameters of the machine learning models, or other suitable operations.

One aspect of the subject matter described in this specification can be embodied in methods that include performing inference operations of a trained machine learning model within the MPC computing environment. More specifically, the method includes identifying, at a client device, a request for processing an input feature vector by a machine learning model using a multi-party computation (MPC) cluster including a plurality of MPC computing systems, the input feature vector having a sequence of M features; for each feature of the input feature vector, encoding, by the client device, the feature to generate an encoded weight vector according to characteristics of the input feature vector; generating, by the client device for each computing system of the plurality of MPC computing systems, a respective share of the encoded weight vectors; providing, by the client device, each respective share of the encoded weight vector to a corresponding computing system of the plurality of MPC computing systems to generate a respective partial prediction for the respective share; collecting, by the MPC cluster, modified partial predictions for the input feature vector from the plurality of MPC computing systems, where each of the modified partial predications is generated based on the respective partial prediction by a corresponding MPC computing system; and generating, by the MPC cluster, a final prediction for the input feature vector corresponding to the request based on the respective partial predictions. Other implementations of this aspect include corresponding apparatus, systems, and computer programs, configured to perform the aspects of the methods, encoded on computer storage devices.

Another aspect of the subject matter described in this specification can be embodied in methods that include training a machine learning model within the MPC computing environment. More specifically, the method includes receiving a plurality of training feature vectors as training examples, each training feature vector having a sequence of M features; for each training feature vector of the plurality of training feature vectors, generating a final prediction using a machine learning model through a plurality of multi-party computation (MPC) computing systems, comprising: for the training feature vector, generating encoded weight vectors for the training feature vector; each encoded weight vector corresponding to each feature in the training feature vector; generating, for each computing system of the plurality of MPC computing systems, a share of the encoded weight vectors; for each computing system of the plurality of MPC computing systems, providing a corresponding share to the computing system to generate a respective partial prediction for the corresponding share using the machine learning model; generating the final prediction based on the respective partial predictions from the plurality of MPC computing systems; and for each training feature vector of the plurality of training feature vectors, updating model parameters of the machine learning model by reducing a loss determined from a loss function for the final prediction and a reference prediction. Other implementations of this aspect include corresponding apparatus, systems, and computer programs, configured to perform the aspects of the methods, encoded on computer storage devices.

The subject matter described in this specification can be implemented in particular embodiments so as to realize one or more of the following advantages. The described techniques can reduce the computation cost and improve the training and inference efficiency. First, the described machine learning model has a much smaller size than other machine learning models. For example, the described machine learning model can include a neural network layer with three layers, e.g., an input layer, a hidden layer, and an output layer. The hidden layer can process input features to generate embeddings, which converts input features from a higher dimensional space to embeddings at a lower dimensional space. In some cases, the hidden layer can be represented by a trained embedding lookup table. The system further process the embeddings using a particular formula, e.g., by the output layer, to determine partial predictions from different MPC computing systems. In addition, the machine learning model can be trained and used to perform inference operations over end-to-end encrypted features within the MPC computing systems. This way, the total computation costs, memory bandwidth requirement for data communication, and memory storage for storing data are reduced by converting features into embeddings with smaller sizes. Moreover, the MPC computing systems can implement a particular protocol so that at least a portion of multiplication operations originally represented in a machine learning model can be converted to add operations, which further reduces the usage of computation resources, particularly for training and using large machine learning models with a large number of model inputs.

In addition, the techniques described in this document can improve user privacy and data security. More specifically, a system implementing the described techniques can train machine models and generate machine learning predictions for input features using cryptographic techniques, such as secure MPC protocols. This protects user privacy with respect to such platforms and preserves the security of the data from breaches during transmission across multiple MPC computing systems, e.g., two different MPC computing systems cannot communicate secret shares with each other absent of consent or permissions.

Furthermore, the described techniques can improve the user privacy and data security without negatively impacting the accuracy of machine learning predictions compared against those generated by models using full private user data (also referred to as cleartext in the following description). The machine learning models described below are non-linear by nature, and implement techniques to generate embeddings for input features (or secret shares of features). Given that, even for input features without private information or labels, the described techniques can generate accurate machine learning predictions.

Moreover, the described techniques are robust such that different feature types and different tasks can be used. For example, the described techniques are compatible with single-value features and multi-value features, and features in a scalar form, vector form, or tensor form. In addition, the described techniques support features with different characteristics, e.g., numerical features (e.g., features represented in numerical formats), categorical features (e.g., features represented by different categories), and ordinal features (e.g., categorical features and may be labeled by numbers). Furthermore, the described techniques can perform various tasks according to particular application needs. The tasks can include, for example, binary classification, multi-class classification, and regression.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an environment for training and performing inference operations of machine learning models using multiple MPC computing systems.

FIG. 2 is a swim lane diagram of an example process for performing inference operations of a machine learning model.

FIG. 3 is a flow diagram that illustrates an example process for performing inference operations of a machine learning model to process input features using multiple MPC computing systems.

FIG. 4 is a flow diagram that illustrates an example process for generating partial predictions for secret shares assigned to a particular MPC computing system.

FIG. 5 is a flow diagram that illustrates an example process for training a machine learning model based on training examples using multiple MPC computing systems.

FIG. 6 is a block diagram of an example computer system.

Like reference numbers and designations in the various drawings indicate like elements.

### DETAILED DESCRIPTION

In general, this document describes systems and techniques for training and performing inference operations of machine learning models for processing feature input while preserving user privacy and ensuring data security. In general, rather than creating and maintaining user profiles at computing systems of other entities, such as content platforms, the user profiles are maintained at the client devices of the users. To train the machine learning models, the client devices of the users can send their encrypted user profiles (e.g., as secret shares of the user profiles) along with other data to multiple computing systems of a secure MPC cluster, optionally via a content platform. For example, each client device can generate two or more secret shares of the user profile and send a respective secret share to each computing system. The computing systems of the MPC cluster can use secure MPC techniques to train and perform inference operations of machine learning models using secret shares of features to prevent any computing system of the MPC cluster (or other party which is not the user itself) from obtaining any private or secure information in cleartext, thereby preserving user privacy. For example, using the secret shares and MPC techniques described in this document enables the machine learning models to be trained and used while the user profile data of each user is encrypted at all times when the data is outside of the user's device.

The described machine learning models are computationally efficient and accurate. Each MPC computing system can have the same model structure but with different model parameters trained through secret shares of training examples. One example machine learning model deployed on an MPC computing system can include one hidden layer configured to generate embeddings for secret shares of features, which are assigned to the MPC computing system. The nodal operation can be an exponential function ƒ=e^{x}, where e is Euler's number, and x is the nodal input. The hidden layer can be represented by an embedding lookup table, which takes secret shares, e.g., encoded weight vectors, as input to determine corresponding embeddings using one-hot encoding, three-hot encoding, four-hot encoding, or other appropriate techniques according to the feature characteristics.

After the machine learning models are trained, the system can store the trained machine learning models in one or more memory units. In addition, the system can deploy the trained machine learning models in multiple MPC computing systems for generating model predictions based on input features. In some implementations, the system can deploy the trained machine learning models to MPC computing systems different from the MPC computing systems for training the models. The input features are encoded or encrypted into multiple secret shares before they are provided to corresponding MPC computing systems, so that MPC computing systems do not communicate their own shares with one another, and each MPC computing system does not have access to the cleartext of the input features, e.g., no access to private or secured features. For example, if an MPC cluster includes two MPC computing systems, a client device can generate a first secret share of the input features for one of the MPC computing systems and generate a second secret share of the input features for the other MPC computing system.

The model predictions can include classification or regression data, or both. For example, the model predictions can include one or more topics, contents, interests, or activities predicted for a user account associated with the input features. In some implementations, the model predictions can also classify or group multiple user profiles into a particular user group, or identify multiple user groups. The system can further provide contents to different user groups given their common interests in a privacy preserving and secure fashion.

### Example System for Training and Performing Inference Operations of Machine Learning Models

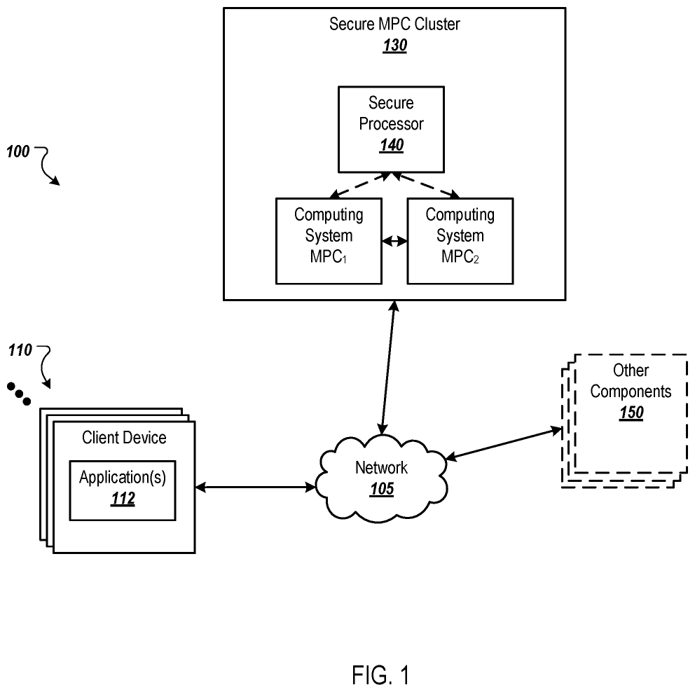

FIG. 1 is a block diagram of an environment 100 for training and performing inference operations of machine learning models using multiple MPC computing systems. The multiple MPC computing systems, for example, can form or be included in a secure MPC cluster 130 shown in FIG. 1. The example environment 100 includes a data communication network 105, such as a local area network (LAN), a wide area network (WAN), the Internet, a mobile network, or a combination thereof. The network 105 connects the client devices 110, the secure MPC cluster 130, and other components 150. In some implementations, the other components 150 can include publishers, websites, and content platforms. The example environment 100 can include many different client devices 110, secure MPC clusters 130, and different other components 150.

A client device 110 is an electronic device that is capable of communicating over the network 105. Example client devices 110 include personal computers, mobile communication devices, e.g., smart phones, and other devices that can send and receive data over the network 105. A client device can also include a digital assistant device that accepts audio input through a microphone and outputs audio output through speakers. The digital assistant can be placed into listen mode (e.g., ready to accept audio input) when the digital assistant detects a “hotword” or “hotphrasex” that activates the microphone to accept audio input. The digital assistant device can also include a camera and/or display to capture images and visually present information. The digital assistant can be implemented in different forms of hardware devices including, a wearable device (e.g., watch or glasses), a smart phone, a speaker device, a tablet device, or another hardware device. A client device can also include a digital media device, e.g., a streaming device that plugs into a television or other display to stream videos to the television, or a gaming device or console.

A client device 110 typically includes applications 112, such as web browsers and/or native applications, to facilitate the sending and receiving of data over the network 105. A native application is an application developed for a particular platform or a particular device (e.g., mobile devices having a particular operating system). The application 112 can cause the client device 110 to send query request for content through the network 105. The content can be provided by one or more remote content providers. In addition, as shown in the FIG. 1, the application 112 can also request the client device to process input features using one or more machine learning models for better retrieving content, e.g., content in which a user of the client device might be interested.

Some resources, application pages, or other application content can include digital component slots for presenting digital components with resource content or application pages. As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, or transmitted from content providers through network 105. Digital components can take the form of video files, audio files, multimedia files, image files, or text files and include advertising information, such that an advertisement is a type of digital component. For example, the digital component may be content that is intended to supplement content of a web page or other resource presented by the application 112. More specifically, the digital component may include digital content that is relevant to the resource content, e.g., the digital component may relate to the same topic as the web page content, or to a related topic. The provision of digital components can thus supplement, and generally enhance, the web page or application content.

When the application 112 loads a resource or application content that includes one or more digital component slots, the application 112 can request a digital component for each slot. In some implementations, the digital component slot can include code (e.g., scripts) that cause the application 112 to request a digital component from a digital component distribution system that selects a digital component and provides the digital component to the application 112 for presentation to a user of the client device 110.

In some cases, it is beneficial to a user to receive digital components related to web pages, application pages, or other electronic resources previously visited and/or interacted with by the user. In some cases, it is beneficial to a user to receive digital components for topics in which the user is interested. However, existing techniques might need data including user historical activities on and across one or more applications, which might cause user private data leak to different third parties. Given that, it is beneficial to protect private and secured user information, and only secret shares of information can be accessed by third parties. One way to achieve it, as described in the document below, is to encode or encrypt user features and then split the encoded features into different shares to assign to different MPC computing systems in the secure MPC cluster 130. Each MPC computing system, e.g., MPC₁ and MPC₂, corresponds to a computing system that is held by or associated with a third party and configured to generate model predictions for the secret shares using machine learning models. This way, the system can provide better-customized digital content to different users and user groups while still preserving user privacy and data security.

In some implementations, the final prediction for input features can relate to a prediction of whether a user will interact with a particular digital component if the digital component is presented to the user in a particular context. For example, the particular context for presenting the digital component to a user can include the geographic location of the client device 110 at the time (if permission is granted by the user), signals describing the content of the electronic resource with which the digital component is presented, and signals describing the digital component, e.g., the content of the digital component, the type of digital components, where on the electronic resource the digital component is presented, etc. In another example, one dimension may be for whether the digital component presented to the user is of a particular type. In this example, the value could be 1 for travel, 2 for cuisine, 3 for movie, etc. Other values and types can also be used.

The secure MPC cluster 130 can train machine learning models to generate, or can be used to perform inference operations of the trained machine learning models to generate, predictions for input features, e.g., features collected and stored by applications 112. As shown in FIG. 1, the secure MPC cluster 130 can include a secure processor 140, and two computing systems MPC₁ and MPC₂. The secure processor 140 and MPC₁ and MPC₂ collaboratively perform secure MPC techniques to train the machine learning models and perform inference operations of the machine learning models.

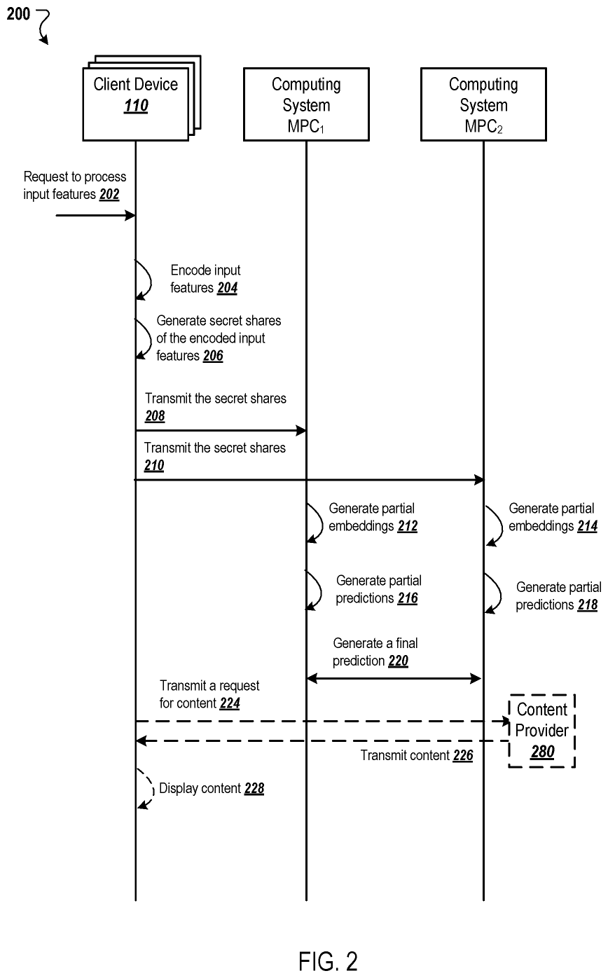

In short, MPC₁ and MPC₂ process respectively-assigned secret shares of encoded input features to generate partial predictions using respectively deployed machine learning models. The MPC computing systems, e.g., MPC₁ and MPC₂, can modify the respective partial predications using respective coefficient values (e.g., a). The details of modifying the respective partial predictions are described in connection with FIG. 2. After modifying the respective partial predictions, one of the MPC computing systems can receive the modified partial predictions from rest of the multiple MPC computing systems to generate a final prediction for the input features. Since the partial predictions are modified by coefficient values in other MPC computing systems, the MPC that receives the modified partial predictions do not have access to the original partial predictions, which ensures the data security when generating the final output.

In some implementations, the system 100 can include a secure processor 140 to collect partial predictions to generate a final prediction for the input features. The secure processor 140 can further include one or more cores or clusters to perform inference operations, or one or more cores or clusters to perform training operations, or both. In some implementations, the secure MPC cluster 130 provides partial predictions generated by respective MPC computing systems (e.g., MPC₁ and MPC₂) to a client device 110. An application 112 of the client device 110 can process the partial predictions to generate a final output for the input features. For example, the client device 110 can combine the partial predictions based on the secure MPC protocol used to generate the partial predictions. In a particular example, if additive secret sharing is used, the client device 110 can add the partial predictions to obtain the final output. The application 112 can further request digital content, e.g., a video clip, audio clip, multimedia clip, image, text, or another unit of content, as described above, using the final output, by transmitting a request with data representing the final output to the server through network 105.

In the training process, the secure processor 140 is configured to determine the final prediction or obtain the final prediction from one of the MPC computing systems. After obtaining the final prediction for input features, the secure processor 140 adjusts model parameters of the machine learning models of MPC₁ and MPC₂ by optimizing a loss function. The loss function is a function quantitating a difference or error between the final prediction and a reference prediction for the input features. The model parameter updates occur during the backward propagation using, for example, gradient decent techniques. In some training situations, one or more of the MPC computing systems in the secure MPC cluster 130 can be used to generate final predictions from partial predictions received from other MPC computing systems.

Although the example MPC cluster 130 includes two computing systems, more computing systems can also be used as long as the MPC cluster 130 includes more than one computing system. For example, the MPC cluster 130 can include three computing systems, four computing systems, or another appropriate number of computing systems. Using more computing systems in the MPC cluster 130 can provide more security and fault tolerance, but can also increase the complexity of the MPC cluster 130 and/or the secure MPC protocol executed by the MPC computing systems in the MPC cluster 130.

The MPC computing systems MPC₁ and MPC₂ can be operated by different entities. In this way, each entity may not have access to the complete input features for a user (e.g., features representing user profiles in cleartext). For example, one of the computing systems MPC₁ or MPC₂ can be operated by a trusted party different from the users. For example, an industry group, governmental group, or browser developer may maintain and operate one of the computing systems MPC₁ and MPC₂. The other computing system may be operated by a different one of these groups, such that a different trusted party operates each computing system MPC₁ and MPC₂. Preferably, the different parties operating the different computing systems MPC₁ and MPC₂ have no incentive to collude to risk the privacy and or security of the data represented by the secret shares received by and/or generated by the computing systems MPC₁ and MPC₂. In some implementations, the MPC computing systems MPC₁ and MPC₂ are separated architecturally and are monitored to not communicate with each other outside of performing the secure MPC processes described in this document. In some cases where consent or permission from users or entities to access particular data or derivatives of particular data has been obtained, different MPC computing systems can use particular MPC protocols to communicate encoded data with each other without risking the privacy and or security of the data.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

### Example Process for Performing Inference Operations of Machine Learning Models

FIG. 2 is a swim lane diagram of an example process 200 for performing inference operations of a machine learning model. Operations of the process 200 can be implemented, for example, by the client device 110, the computing systems MPC₁ and MPC₂ of the MPC cluster 130, and the secure processor 140. Operations of the process 200 can also be implemented as instructions stored on one or more computer readable media, which may be non-transitory, and execution of the instructions by one or more data processing apparatus can cause the one or more data processing apparatus to perform the operations of the process 200. Although the process 200 and other processes below are described in terms of a two computing system MPC cluster 130, MPC clusters having more than two computing systems can also be used to perform similar processes. Although only one secure processor 140 is shown, the secure processor 140 itself can include one or more computing cores or clusters.

A client device 110 can receive a request to perform inference operations of trained machine learning models for processing input features (202). The request can be initiated or issued by one or more applications 112 deployed on the client device 110. In some implementations, the request can be initiated by other components in the system 100, e.g., a content platform. The request include data specifying two or more MPC computing systems in the multiple MPC computing systems, e.g., the secure MPC cluster 130 of FIG. 1, to process secret shares of the encoded or encrypted input features. In some implementations, the secret shares are additive secret shares that can be combined by adding the secret shares together to obtain the input features in cleartext.

In some implementations, the input features can include data representing user profiles. For example, a feature can be an individual measurable property or characteristic of a phenomenon or action being observed, the phenomenon or action being associated with a user. More specifically, the user profile for a user can include data related to events initiated by the user and/or events that could have been initiated by the user with respect to electronic resources, e.g., web pages or application content. The events can include views of electronic resources, views of digital components, user interactions, or the lack of user interactions, with (e.g., selections of) electronic resources or digital components, conversions that occur after user interaction with electronic resources, and/or other appropriate events related to the user and electronic resources. The user profile for a user can also include data indicating user attributes of the user, e.g., demographic information, location information, etc.

The input features can include numerical features (features represented by numerical values), categorical features (features represented by categorical groups), and optionally ordinal features (categorical data with a set ordering or scale to it).

The input features can be presented in different forms or data structures. For example, an input feature can be a scalar, a vector, or a tensor. For cases where an input feature is a vector (also referred to as an input feature vector), the input feature vector can include a sequence of features, each feature having a number of possible values (also referred to as a cardinality of the feature). The total number of features in the sequence of features (e.g., M total features, where M includes 7, 13, 17, 20 or other suitable numbers) and the cardinality of each feature can affect the total computation costs for training and using a machine learning model.

In generation, each application 112 can store data associated with a user profile in memory local or remote to the client device. In some cases, the applications 112 can process input data (e.g., user profile data) to generate encoded input features. The applications 112 can provide the input features to the client device 110. The applications 112 or the device 110 can issue a request to the secure MPC cluster 130 to process the generated input features. In some other cases, the applications 112 provide raw user profile data to the client device 110, and it is the client device 110 that processes the raw user profile data to generate input features. For simplicity, the description below is generally based on using a client device to generate input features from raw user profile data.

Upon receiving the request to process input features and the input features from the applications 112, the client device 110 can encode each input feature in the input feature vector into an encoded weight vector according the characteristics of the input feature vector (204). Each encoded weight vector can have a size of K. For example, the size K can be 10, 30, 50, 100, 1000, or other suitable values.

As described above, the characteristics of the input features generally refer to whether a feature is a numerical feature or a categorical feature. For a categorical feature, the client device 110 can determine an encoded weight vector for the categorical feature using one-hot encoding techniques. For a numerical feature, the client device 110 can determine an encoded weight vector for the numerical feature using three-hot encoding or four-hot encoding techniques.

More specifically, for categorical features with low cardinality (e.g., one or a few possible values for each categorical feature), the client device 110 can encode the categorical values with one-hot encoding into an array. The length or size of the array is the cardinality of the categorical feature, and each element of the array can have a value of one if the element position corresponds to the value of the categorical feature, or a value of zero if the element position does not correspond to the value of the categorical feature. Other appropriate values can also be used.

For categorical features with high cardinality (e.g., tens, hundreds, or more possible values for each categorical feature), the client device 110 can first reduce the cardinality. One way to reduce the cardinality is to split a categorical feature (e.g., F) with high cardinality into n categorical features ({F1, F2, . . . , Fn}, each one having medium to low cardinality. The size n can be, e.g., 2, 3, 5, or more based on the model size and computation requirements. In this way, the combined cardinality of all split categorical features is much smaller than the cardinality of the original categorical feature F. In addition to reducing the cardinality, the client device 110 can implement distributed point functions (DPFs), which is generally a cryptographic primitive that allows two distributed processes to share a piece of information, and compute functions of their shared information, without revealing the information itself to either process. The client device 110 can encode each categorical value into a pair of DPFs that can be transmitted using less bandwidth compared to the one-hot encoding techniques.

Referring to the numerical features, the client device 110 (or one or more applications 112 installed on the client device 110) can implement an interpolation technique to convert numerical features into two or more categorical features. For example, the interpolation technique can be a spline interpolation, which is a function made up of piecewise polynomials that each have a specific interval. The points where two of the piecewise polynomials meet is referred to as control points or knots. More specifically, assuming a 2-dimensional space, given n+1 fixed knots {(xᵢ, yᵢ): i=0, 1,2, . . . , n) where x₀<x₁< . . . <xₙ. The term x refers to observed feature values of the numerical features, and the term y can refer to any measurable value associated with x. For example, the term y can be the embedding for the feature x in the K-dimensional space. A cubic spline interpolation having piecewise polynomials of third degree can be used to interpolate values within each pair of two neighboring knots (xᵢ₋₁, yᵢ₋₁) and (xᵢ, yᵢ). The resulting spline is continuous and has continuous first derivatives.

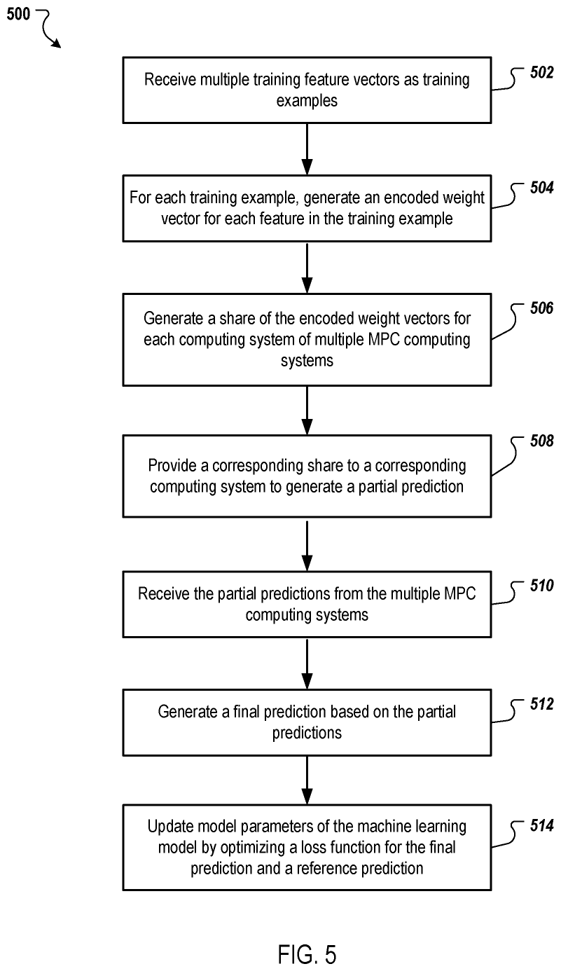

To determine positions of each knots of the above-noted multiple knots, the client device 110 (or one or more applications 112 installed on the client device 110) can determine quantiles for numerical values so that the numerical feature values are evenly assigned into n buckets, each bucket having a roughly similar number of numerical values. For example, for n+1 fixed knots {(xᵢ, yᵢ): i=0, 1,2, . . . , n} and for N total number of input features, each bucket can be assigned with roughly N/n numbers of input features. Quantile process is effective for machine learning computations because it can avoid unnecessary computational costs of pre-processing numerical features. In some implementations, the system (e.g., the secure MPC cluster 130) can further update or refine the quantile process during training the machine learning models. Example details of updating the quantile process (positions of knots) are described in connection with the training process below (e.g., in connection with FIG. 5).

After the client device 110 obtains a sequence of knots, the client device 110 (or corresponding applications 112) converts the numerical values into a weights sum or a weighted average of embeddings. For a particular numerical feature in the input feature vector xₖ₊₁+t, where t<xₖ₊₂−xₖ₊₁, falling into the bucket [xₖ₊₁, xₖ₊₂], where k represents the k-th knot in the sequence of knots in the quantile process, and the term t represents a positive value. The corresponding embedding interpolated for the particular numerical feature can be determined by a weighted average of {yₖ, yₖ₊₁, yₖ₊₂, yₖ₊₃} if the particular numerical feature does not belong to the two ends of a sequence of buckets. The weighted average can be expressed as:

$$y = {w}_{k} \times {y}_{k} + {w}_{k + 1} \times {y}_{k + 1} + {w}_{k + 2} \times {y}_{k + 2} + {w}_{k + 3} \times {y}_{k + 3} \qquad Equation ( 1 )$$

The terms {wₖ, wₖ₊₁, wₖ₊₂, wₖ₊₃} represent the interpolation weights for the cubic spline interpolation according to the standard cubic spline rules. These weights are represented as shown below:

$${w}_{k} = {h}_{10} ( i ) \times \frac{- 1}{2 ( {x}_{k + 1} - {x}_{k} )} ,$$

$${w}_{k + 1} = {h}_{00} ( t ) + {h}_{10} ( t ) \times ( \frac{- 1}{2 ( {x}_{k + 2} - {x}_{k + 1} )} + \frac{1}{2 ( {x}_{k + 1} - {x}_{k} )} ) + {h}_{11} ( t ) \times \frac{- 1}{2 ( {x}_{k + 2} - {x}_{k + 1} )} ,$$

$${w}_{k + 2} = {h}_{01} ( t ) + {h}_{10} ( t ) \times ( \frac{1}{2 ( {x}_{k + 2} - {x}_{k + 1} )} ) + {h}_{11} ( t ) \times ( \frac{- 1}{2 ( {x}_{k + 3} - {x}_{k + 2} )} + \frac{1}{2 ( {x}_{k + 2} - {x}_{k + 1} )} ) ,$$

$$and$$

$${w}_{k + 3} = {h}_{11} ( t ) \times \frac{1}{2 ( {x}_{k + 3} - {x}_{k + 2} )} .$$

Here, the terms {h₁₀ (t), h₀₀(t), h₀₁ (t), h₁₁(t)} are standard coefficient functions for the cubic interpolation polynomial function.

In this way, the client device 110 (or corresponding applications 112) can treat a numerical feature the same way as it treats a categorical feature with n+1 distinct values, except that when determining the embeddings using an embedding lookup table, the client device 110 determines the embedding for a numerical feature as a weighted average of four adjacent knots if the numerical feature value falls into the bucket [xₖ₊₁, xₖ₊₂]. The corresponding weights for the four embeddings are {wₖ, wₖ₊₁, wₖ₊₂, wₖ₊₃}. The system can structure the weight values into an encoded weight vector before providing to the MPC computing systems, and the corresponding embeddings for the numerical value can be determined using the encoded weight vector and embedding values stored in the lookup table at a corresponding MPC computing system. This encoding technique for numerical feature values falling in a bucket (not the left-most and the right-most bucket) is also referred to as the four-hot encoding.

In addition, for numerical feature values that fall in the left-most bucket in a sequence of buckets, i.e., [x₀, x₁] or k=1, the above Equation (1) still holds for three neighboring embedding values, i.e., {y₀, y₁, y₂}. The corresponding weight values {w₀, w₁, w₂} can be presented below as:

$${w}_{0} = {h}_{00} ( t ) + {h}_{10} ( t ) \times ( \frac{- 1}{2 ( {x}_{1} - {x}_{0} )} ) + {h}_{11} ( t ) \times \frac{- 1}{2 ( {x}_{1} - {x}_{k 0} )} ,$$

$${w}_{1} = {h}_{01} ( t ) + {h}_{10} ( t ) \times ( \frac{1}{2 ( {x}_{1} - {x}_{0} )} ) + {h}_{11} ( t ) \times ( \frac{- 1}{2 ( {x}_{3} - {x}_{1} )} + \frac{1}{2 ( {x}_{1} - {x}_{0} )} ) ,$$

$$and$$

$${w}_{2} = {h}_{11} ( t ) \times \frac{1}{2 ( {x}_{2} - {x}_{1} )} .$$

Furthermore, for numerical feature values that fall in the right-most bucket in a sequence of buckets, i.e., [xₙ₋₁, xₙ] or k=n−2, the above Equation (1) still holds for three neighboring embedding values, i.e., {yₙ₋₂, yₙ₋₁, yₙ}. The corresponding weight values {w₀, w₁, w₂} can be presented below as:

$${w}_{n - 2} = {h}_{10} ( t ) \times \frac{- 1}{2 ( {x}_{n - 1} - {x}_{n - 2} )} ,$$

$${w}_{n - 1} = {h}_{00} ( t ) + {h}_{10} ( t ) \times ( \frac{- 1}{2 ( {x}_{n} - {x}_{n - 1} )} + \frac{1}{2 ( {x}_{n - 1} - {x}_{n - 2} )} ) + {h}_{11} ( t ) \times \frac{- 1}{2 ( {x}_{n} - {x}_{n - 1} )} ,$$

$$and$$

$${w}_{n} = {h}_{01} ( t ) + {h}_{10} ( t ) \times ( \frac{1}{2 ( {x}_{n} - {x}_{n - 1} )} ) + {h}_{11} ( t ) \times ( \frac{1}{2 ( {x}_{n} - {x}_{n - 1} )} ) .$$

For the purposes of this document, the above encoding techniques for numerical features falling into the left-most bucket and the right-most bucket are also referred to as the three-hot encoding.

In some implementations, the client device 110 generates an encoded weight vector for a categorical feature using the one-hot encoding, or for a numerical feature using the four-hot encoding or three-hot encoding. The encoded weight vectors are split into secret shares for corresponding MPC computing systems. Each corresponding MPC computing system processes the respective shares using respective embedding lookup tables stored in the corresponding MPC computing system.

More specifically, the client device 110 generates, for each MPC computing system in the secure MPC cluster, a respective secret share of the encoded input features (206). The respective secret shares can be additive so that the secret shares can be combined to form the encoded input features generated from the input feature vector, e.g., by adding the secret shares if additive secret sharing is used. In some cases, the encoded input features can be encoded weight vectors forming from the above-noted weights using one-hot encoding, three-hot encoding, or four-hot encoding.

As shown in FIG. 1, the secure MPC cluster 130 can include two MPC computing systems (e.g., MPC₁ or MPC₂). Given that, the client device 110 can split the encoded weight vectors for the input features into two secret shares. Each of the two secret shares is provided to a corresponding MPC computing system (MPC₁ or MPC₂), and the two secret shares do not have shared information from the input feature. Nor does any one of the respective secret shares reveal the private user data or secured data. This way, the data privacy and security is guaranteed. The system can implement standard techniques to split the encoded weight vectors into respective secret shares. The secret shares can have the same data structure as the encoded weight vectors.

Although the client device 110 described in this document generally divides the encoded weight vectors into different secret shares for different MPC computing systems, in some implementations, the client device 110 can directly split the feature vector into secret shares of the feature vector before encoding, and provide the secret shares of the feature vector to corresponding MPC computing systems (e.g., MPC₁ or MPC₂). Next, each MPC computing system is configured to convert shares of numerical features (if any) into shares of categorical features, and encode (e.g., generate embeddings) the shares by processing the shares of categorical features using a respective embedding lookup table. The conversion process is similar to those described above.

The client device 110 transmits the secret shares of encoded input features (e.g., the encoded weight vectors) to corresponding MPC computing systems. As shown in FIG. 2, the client device 110 transmits a first secret share of the encoded weight vectors to the computing system MPC₁ (208), and transmits a second secret share of the encoded weight to the computing system MPC₂(210). In some implementations, the client device 110 can also transmit a request to process the secret shares to the secure MPC cluster 130. Alternatively, the MPC computing systems in the cluster 130 automatically initiates the process of determining embeddings for shares of features after receiving the secret shares.

After receiving a first share of the encoded features, the computing system MPC₁ can generate a first partial embedding for the first share of encoded features (212). Similarly, after receiving a second share of the encoded features, the computing system MPC₂ can generate a second partial embedding for the second share of encoded features (214). To determine a partial embedding for a share of encoded features, a computing system in the secure MPC cluster 130 can use an embedding lookup table. The embedding lookup table can include rows of embedding values determined during the training process using training examples. Each row of the embedding lookup table can represent a M-size vector in a K-dimensional embedding space. The size K can be, e.g., 20, 40, 60, 100, or other suitable numbers and the size M can be, e.g., 3, 8, 12, 14, or other suitable numbers. Each MPC computing systems has a different embedding lookup table with different parameters for processing its share of the encoded features.

For example, one example process for determining a partial embedding using a MPC computing system can include a multiplication between a secret share of encoded weight vector and an embedding lookup table deployed in the MPC computing system. More specifically, for the j-th feature xⱼ in the input feature vector x, where 1≤j≤M, one can assume that LUTⱼ is the embedding table that maps each of all possible values for the j-th feature to a K-dimensional embedding. One can further assume that the lookup table LUTⱼ has |xⱼ| entries, each entry is denoted as LUT_{j,m} where |*| represents the cardinality, and m ∈ [0, |xⱼ|). The term LUT_{j,m} is a K-dimensional vector, where K can be 30, 40, 50, 100 or other suitable numbers. Accordingly, for a categorical feature xⱼ with M cardinality (e.g., M can include 5, 10, 15, 20, or other suitable numbers), a first MPC computing system (e.g., MPC₁) can have a first embedding lookup table [LUT_{j,m}]₁ and a second MPC computing system (e.g., MPC₂) can have a second embedding lookup table [LUT_{j,m}]₂. For the purpose of this document, a secret share of encoded features, weights, or lookup table parameters are typically represented using a bracket with subscript indicating which MPC computing system is assigned with the secret share.

The first MPC computing system can multiply the first embedding lookup table with the first share of encoded weight vector [wₘ]₁, i.e. Σₘ₌₀^{M}([LUT_{j,m}]₁×[wₘ]₁). Similarly, the second MPC computing system can multiply the second embedding lookup table with the second share of encoded weight vector [wₘ]₂, i.e., Σₘ₌₀^{M}([LUT_{j,m}]₂×[wₘ]₂). The results of the two multiplications are two secret shares of embeddings [Eⱼ]₁ and [Eⱼ]₂ of K dimension held by MPC₁ and MPC₂ respectively. The MPC computing systems collaboratively obtain the embedding for the feature vector. The combination of the embeddings are described in greater detail below.

The MPC computing systems (e.g., MPC₁ and MPC₂) can compute partial predictions based on the secret share of embeddings (216 and 218). For the machine learning model described in this document, the system can determine the model prediction using the analytical formula below:

$$\hat{{P}_{ι}} = {C}_{0} + {\sum }_{k = 1}^{K} ( {C}_{k} \times {e}^{( {\sum }_{m = 1}^{M} {E}_{i , m , k} )} ) \qquad Equation ( 2 )$$

where E_{i,m,k} is the embedding generated for i-th feature xᵢ, and \hat{P}ₜ is the model prediction for the i-th feature xᵢ. This formula is comparable for a feedforward neural network with the following properties. First, the neural network has three layers, e.g., an input layer for processing the input features, a hidden layer for generate hidden states (embeddings) for input features, and an output layer for generating model predictions for the embeddings. In addition, the neural network can include an embedding lookup table, which is trainable using training examples. Furthermore, the hidden layer can have fixed weight values (all ones) for all nodes in the hidden layer. These fixed weight values are constant during the training process. The nodal activation function for the hidden layer can be an exponential function, e.g., a natural exponentiation. Moreover, the output layer of the neural network has learnable weights C₀ and Cₖ, k ϵ (1, K).

Given that, the first MPC computing system MPC₁ generates a first partial model prediction [symbol] ₁ for the share of embedding [Eᵢ]₁ using Equation (2). Similarly, the second MPC computing system MPC₁ generates a second partial model prediction [symbol] ₂ for the share of embedding [Eᵢ]₂ using Equation (2).

The secure MPC cluster 130 can fetch the partial predictions from the different MPC computing systems (MPC₁ and MPC₂) to generate a final prediction for the i-th feature (220). To combine the partial predictions, the system can convert multiplication operations into add operations due to the nature of exponential functions, i.e., e^{E}=e^{E}^{₁}^{+E}^{₂}=e^{E}^{₁}×e^{E}^{₂}. By converting multiplication operations into add operations using the described system, substantial computation power and time can be saved for processing input using respective machine learning models, particularly for giant models with huge amount of input data. One example algorithm for combining partial predictions into a final prediction is described as follows:

Assuming that MPC₁ holds conversion coefficients {α_{1,1}, α_{2,1}}, and MPC₁ holds conversion coefficients {α_{1,2}, α_{2,2}}, where α_{1,1}×α_{1,2}+α_{2,1}×α_{2,2}=1. These coefficients can be calculated offline before training and using the machine learning models within the MPC computing environment.

Although the MPC computing systems generally do not communicate the secret shares of the encoded features with one another, MPC₁ and MPC₂ can transmit functions of embeddings (or partial predictions) to each other to determine the final prediction. In other words, MPCs can communicate “encoded” partial predictions in some occasions. For example, MPC₁ can send e^{[E]}^{₁}×α_{1,1}, to MPC₂, and MPC₂ can send e^{[E]}^{₂}×α_{2,2} to MPC₁. Based on the communicated data, MPC₁ calculates [symbol] ₁=e^{[E]}^{₂}×α_{2,2}×e^{[E]}^{₂}×α_{2,1}, and MPC₂ calculates [symbol] ₂=e^{[E]}^{₁}×α_{1,1}×e^{[E]}^{₂}×α_{1,2}. In this case, each MPC computing system can obtain the final output based on the modified partial prediction from other MPC computing system(s). The partial predictions are modified by parameters a so that no MPC computing system knows the exact partial predictions from other MPCs, which protects the data security. In some implementations, the secure MPC cluster 130 can obtain the final prediction by combining the partial predictions from MPC₁ and MPC₂ using a secure processor (e.g., secure processor 140 of FIG. 1). In some implementations, one or more MPC computing systems of a MPC cluster can generate a final prediction by combining “encoded” particular predictions received from other MPC computing systems. One example algorithm for combining partial predictions are expressed as below:

$$\hat{P} = {e}^{E} = {e}^{{[ E ]}_{1} + {[ E ]}_{2}} ( {α}_{1 , 1} \times {α}_{1 , 2} + {α}_{2 , 1} \times {α}_{2 , 2} ) = [ {1}_{} + [ {2}_{} \qquad Equation ( 3 )$$

In addition, for MPC computing systems that natively support integer operations but not fractional (non-integer) values, the system (e.g., system 100 of FIG. 1 or the MPC computing systems or the secure MPC cluster 130 in the system 100) can implement fixed-point arithmetic to convert fractional values into integers. For example, given a fractional number of 0.125, the system can scale it up by 16384 and represent the fractional number as 2048. In this example, the system can convert a fixed point value (e.g., 2048) back to its actual value (e.g., 0.125) by dividing the fixed point value by 16384.

In some implementations, the client device 110 can transmit a request for content to the content provider 280 (224). For example, the application 112 can transmit, to the content platform 150, a request for a digital component in response to loading an electronic resource that has a digital component slot. The request can be sent to the system through the network with or after the request to process encoded user input features.

The content provider 280 can determine content that is likely to be of interest to the user. For example, the content platform 280 can select a digital component based on the final prediction and provide the digital component to the application 112 (226). In some implementations, the content platform 150, in collaboration with the application 112, selects a digital component based on the final prediction(s).

In some cases, the client device 110 can receive partial predictions from the MPC computing systems, and generate a final prediction based on the partial predictions for the input features. The client device 110 can request for a digital content from the content provider 280 using the final prediction. In some implementations, the final prediction can include a digital content. In this case, the partial predictions can include shares of data identifying the digital content or secret shares of the digital content.

The client device can display the content on the display (228). For example, the application 112 can display a received digital component in a digital component slot of an electronic resource. In some cases, the system can provide the final prediction to the applications 112 on the client device 110 for one or more down streaming operations (e.g., facial unlock, image processing, or other suitable tasks).

### Example Process for Performing Inference Operations of the Machine Learning Models

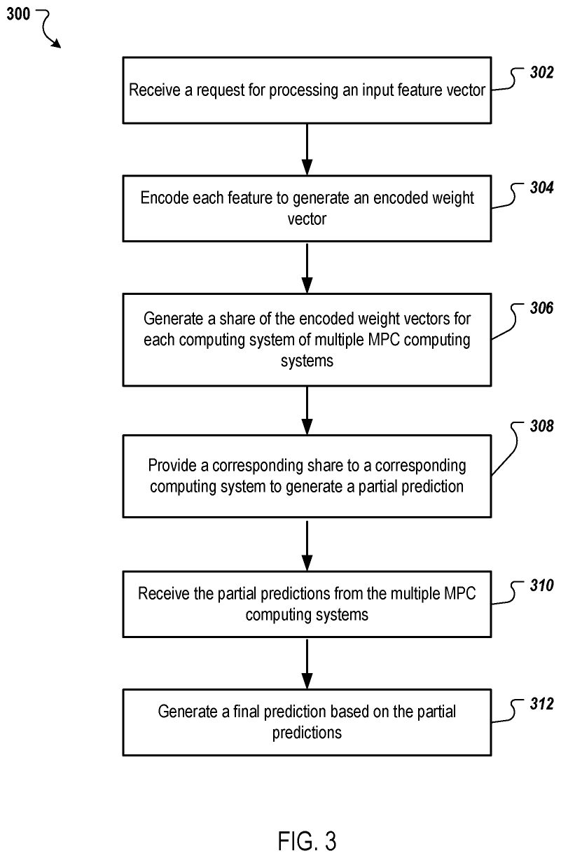

FIG. 3 is a flow diagram that illustrates an example process 300 for performing inference operations of a machine learning model to process input features using multiple MPC computing systems. Operations of the process 300 can be implemented by a client device and a secure MPC cluster, for example, by the client device 110 of FIG. 1, e.g., by one or more processors on the client device 110, and by the secure MPC cluster 130 of FIG. 1. Operations of the process 300 can also be implemented as instructions stored on one or more computer readable media which may be non-transitory, and execution of the instructions by one or more data processing apparatus can cause the one or more data processing apparatus to perform the operations of the process 300.

A client device of the system identifies a request for processing features by a machine learning model within the MPC environment (302). The client device can receive a request issued from the application 112 installed on the client device. In some cases, the client device can issue the request. The input feature can include features for events or data associated with a user when the user uses the application. The features can be at least a subset of all features associated with the client device or a user using or owning the device, and the features can include raw log data or derived data from raw log data. As described above, the features can be in various forms, e.g., a scalar, vector, or tensor form. For example, the features can be structured as an input feature vector having a sequence of M features. M is a positive integer, which can be 5, 10, 15, 20, or other suitable numbers. The features can include numerical features, categorical features, or ordinal features. The MPC environment can include multiple MPC computing systems (e.g., MPC₁ and MPC₂ of FIG. 1). The MPC environment can be implemented as a secure MPC cluster having multiple MPC computing systems.

The client device encodes each feature of the input feature vector (304). In general, the client device generates encoded weight vectors using different encoding techniques according to different characteristics of the input feature vector. For example, the client device can encode a categorical feature using the one-hot encoding techniques to generate a weight vector, each position of the weight vector corresponding to a possible value for the categorical feature. As another example, the client device can encode a numerical feature using the three-hot encoding or four-hot encoding to generate a weight vector.

To encode features into weight vectors, the client device first determines a sequence of fixed knots for the input feature vector by a quantile process. The number of fixed knots are K+1 and each knot includes a pair of a fixed numerical feature and a fixed embedding for the numerical feature. The two neighboring fixed knots form a bucket so that the fixed knots can form a sequence of K buckets.

The client device allocates a numerical feature of the input feature vector into a corresponding bucket based on the numerical feature value and the positions of the sequence of buckets.

The client device uses interpolation techniques (e.g., a cubic interpolation) to represent the numerical feature as a weighted sum of three or four fixed embeddings associated with the corresponding bucket. More specifically, for numerical features fall into the left-most or right most bucket in a sequence of buckets, the client device would use the three-hot encoding. For numerical features fall into other buckets away from the two end buckets of the sequence of buckets, the client device would use the four-hot encoding.

The client device generates the encoded weight vector for the numerical feature based on the multiple weight values in the weighted sum. The weight vector can include a respective weight value in each of the three or four consecutive positions of the weight vector. These weight values correspond to embedding knots of a sequence of knots for interpolating the embedding for the numerical feature. Example details of encoding the features at the client device are described above in connection with FIG. 2.

Although the quantile process could be learning when training the machine learning models in the MPC environment, the system (e.g., the client device) can refine the quantiles when performing inference operations of the machine learning models. Example details of refining the quantile process are described in connection with FIG. 5.

The client device generates a respective secret share of the encoded weight vectors for each MPC computing system of the multiple MPC computing systems (306). The respective secret shares can form the encoded weight vectors. For example, the client device can split an encoded weight vector of the multiple encoded weight vectors into two secret shares. The first secret share can be assigned to a first MPC computing system and the second secret share can be assigned to a second MPC computing system. The two secret shares are additive so that when the two secret shares are combined in a particular way, the original encoded weight vector is reconstructed. The process of generating secret shares for different MPC computing systems can be performed using standard MPC protocols.

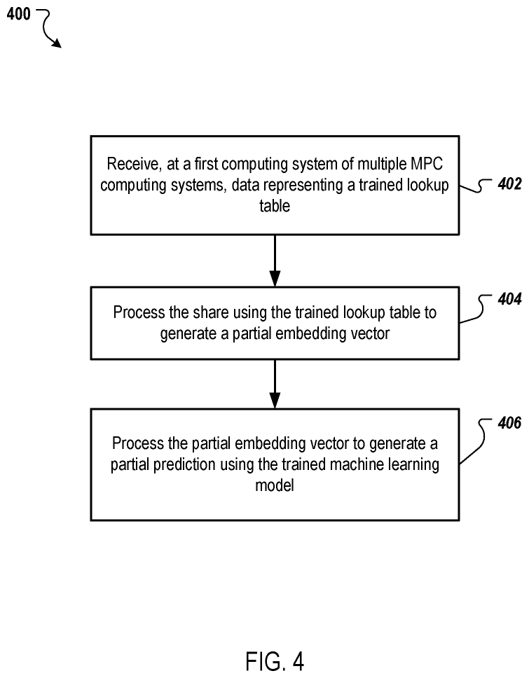

The client device provides each of the respective secret shares of the encoded weight vector to a corresponding computing system of the plurality of MPC computing systems to generate a respective partial prediction for the respective secret share (308). To generate a respective partial prediction, the corresponding MPC computing system can process the secret shares of encoded features (e.g., weight vectors) using a respective embedding lookup table. The details of the process are described above in connection with FIG. 2 and will be summarized again in connection with FIG. 4.

A particular MPC computing system can receive modified partial predictions from the rest of the multiple MPC computing systems (310). As described above, each MPC computing system can modify or encode its own partial prediction using a respective coefficient (e.g., α), and a particular MPC computing system (e.g., MPC₁) can receive the modified partial predictions from other MPC computing systems to generate a final prediction. The usage of modified or encoded partial predictions can prevent secured data from leaking across different MPC computing systems. In some cases, the secure MPC cluster (or more precisely, a secure processor in the secure MPC cluster) can collect modified partial predictions from different MPC computing systems. The secure processor includes particular privacy mechanism so that no data leak would occur when collecting the partial predictions from MPC computing systems. In some implementations, the client device can collect the partial predictions from multiple MPC computing systems to obtain final predictions faster.

The particular MPC computing system can generate a final prediction for the input based on the modified partial predictions from other MPC computing systems (312). In some cases, the secure processor in the secure MPC cluster is configured to determine a final prediction for partial predictions during the inference operations. The secure processor can combine the partial predictions in an additive fashion. Example details of the combination are described above in connection with FIG. 2.

FIG. 4 is a flow diagram that illustrates an example process 400 for generating partial predictions for secret shares assigned to a particular MPC computing system. Operations of the process 400 can be implemented by a MPC computing system in a secure MPC cluster, for example, by MPC₁ or MPC₂ 110 of FIG. 1. Operations of the process 400 can also be implemented as instructions stored on one or more computer readable media which may be non-transitory, and execution of the instructions by one or more data processing apparatus can cause the one or more data processing apparatus to perform the operations of the process 400.

The MPC computing system receives data representing a trained lookup table (402). For example, the MPC₁ of FIG. 1 can receive data representing a trained lookup table. The data representing the trained lookup table can be stored in a memory internal to the system, or external to the system, or both. The trained lookup table is created and trained for the embedding layer of a machine learning model during the training of the machine learning model using the MPC computing systems. The trained lookup table include data representing a share of embeddings corresponding to a share of encode features assigned to the MPC computing system. The embedding lookup table is trained using training examples within the MPC environment. Each row or column of the embedding lookup table includes a sequence of values representing an embedding of a knot in a sequence of knots for the quantile process. The details of the quantile process are described in connection with FIG. 2. Updating or refining the quantile process to determine knot positions are described in connection with FIG. 5.

The MPC computing system further receives a corresponding secret share of encoded features and processes the received secret share using the trained lookup table to generate a partial embedding vector (404). One example process to process the encoded features can be a multiplication of the trained lookup table with the secret share of weight vectors. An example detailed process for performing the multiplication is described in connection with FIG. 2.

The MPC computing system further processes the partial embedding vector to generate a partial prediction using the trained machine learning model (406). As described above, the MPC computing system can generate a partial prediction for the share of embedding using an analytical formula. The formula corresponds to a particular forward feeding neural network, e.g., all data flows in the same direction. The particular neural network can include an input layer for processing the input features, a hidden layer for processing the input data to generate embedding (or hidden states) for the input data, and an output layer to generate a prediction for the embedding. The nodal weights of all nodes in the hidden layer are set to value one and remain unchanged during training. The nodal activation function of each node in the hidden layer is an exponential function, e.g., a natural exponential function ƒ=e^{x}, or other suitable exponential function. However, for an exponential function ƒ′=a^{x} different from the natural exponential function, the analytical formula is scaled up or down by a factor of log function based on the base number a of the exponential function and Euler's number e. More details of the analytical formula and the corresponding neural network structures are described in connection with FIG. 2.

### Example Process for Training Machine Learning Models

FIG. 5 is a flow diagram that illustrates an example process 500 for training a machine learning model based on training examples using multiple MPC computing systems. Operations of the process 500 can be implemented, for example, by the MPC cluster 130 of FIG. 1, or more specifically, a secure processor 140 in the cluster 130. Operations of the process 500 can also be implemented as instructions stored on one or more computer readable media which may be non-transitory, and execution of the instructions by one or more data processing apparatus can cause the one or more data processing apparatus to perform the operations of the process 500.

The secure processor receives multiple training feature vectors as training examples (502). Each training feature vector has a sequence of M features, where M can be 5, 10, 14, 19, or other suitable numbers. The features can include numerical features and categorical features. The secure processor can convert numerical features into categorical features as described in connection with FIG. 2.

For each training feature vector of the plurality of training feature vectors, the secure processor in the secure MPC cluster generates a final prediction using a machine learning model through a plurality of multi-party computation (MPC) computing systems. The process for generating the final prediction for a training feature vector includes the following steps.

For the training feature vector, the secure processor generates multiple encoded weight vectors for the training feature vector (504). Each of the multiple encoded weight vectors correspond to a feature in the training feature vector. The encoding techniques are similar to those described in connection with FIG. 2. However, in the training step, the quantile process is also under training, accordingly, the positions for a sequence of fixed knots are changeable during the training process, which also affects the interpolation results underneath the encoding process. The details of updating or refining the quantiles are described below.

The secure processor generates a secret share of the encoded weight vectors for each computing system of the plurality of MPC computing systems (506). For example, the secure processor can generate a first secret share of the encoded weight vectors for a first MPC computing system (e.g., MPC₁ of FIG. 1), and generates a second secret share of the encoded weight vectors for a second MPC computing system (e.g., MPC₂ of FIG. 1). The splitting process can be performed following a secure MPC protocol, similar to those described in connection with FIG. 2.

The secure processor provides the corresponding secret share to each corresponding MPC computing system of the multiple MPC computing systems (508) The corresponding computing system generates a respective partial prediction for the corresponding secret share using a machine learning model deployed in the MPC computing system. The partial prediction is generated using current model parameters of the machine learning model. The current model parameters are under update during the training process. The general process for processing the corresponding secret share using an embedding lookup table is similar to the inference steps described above, e.g., a multiplication process between the share of embedding lookup table and the secret share of encoded features. However, the embedding lookup table is also under training, so the parameters (e.g., embedding values) in the lookup table are not accurate and under joint update during the training process. After obtaining the embedding, the system can use the analytical formula to determine a partial prediction. However, the coefficients C₀ and Cₖ are changeable during the training process. Although each MPC computing system can have different model instances (e.g., different embedding values for the embedding lookup tables, and different coefficients for the formula used in each MPC computing system), the model structure is substantially identical. Accordingly, the training process described in this document is based on a single machine learning model, for the purpose of simplicity and ease of clarification.

The secure processor receives the partial predictions from the multiple MPC computing systems (510) and then generates a final prediction based on the respective partial predictions received from the plurality of MPC computing systems (512). The process of combining partial predictions into a final prediction is the same as the inference applications (see Equation (3)). The coefficients α for combination are predetermined offline and are not updating during the training process.

The secure processor updates model parameters of the machine learning model by optimizing a loss function for the final prediction and a reference prediction for each training feature vector of the plurality of training feature vectors (514). A general loss function measures accumulated errors or discrepancies between the model predictions and reference predictions for the training input. An example loss function can be expressed as Σ ƒ(\hat{P}, P_{ref}), where the term P is determined according to Equation (3), and the term P_{ref} represents the reference prediction.

To update the model parameters, the secure processor can perform stochastics gradient descent techniques during backward propagation. It is accordingly important to calculate the gradients correctly.

For regression tasks, the loss function can be a mean-square-error function, which can be expressed as below:

$$f = \frac{1}{N} \times {\sum }_{i = 1}^{N} {( \hat{{P}_{ι}} ( {x}_{i} ) - {P}_{ref , i} )}^{2} \qquad Equation ( 4 )$$

where the term \hat{P}ₜ(xᵢ) is a function for the i-th feature vector of the N training examples, and the term P_{ref,i} represents the reference for the i-th feature vector. The gradient can be calculated as below:

$$\frac{df}{{d}_{{C}_{o}}} = \frac{2}{N} \times {\sum }_{i = 1}^{N} ( \hat{{P}_{ι}} - {P}_{ref , i} ) \qquad Equation ( 5 )$$

$$\frac{df}{{d}_{{E}_{k}}} = - \frac{2}{N} \times {\sum }_{i = 1}^{N} ( ( \hat{{P}_{ι}} - {P}_{ref , i} ) \times {e}^{( {\sum }_{m = 1}^{M} {E}_{i , m , k}} ) ) \qquad Equation ( 6 )$$

The gradient for each embedding can be calculated using the chain rule, i.e.,

$$\frac{df}{{d}_{{E}_{k}}} = \frac{2}{N} \times {\sum }_{i = 1}^{N} ( \hat{{P}_{ι}} - {P}_{ref , i} ) \times {C}_{k} \times {e}^{( {\sum }_{m = 1}^{M} {E}_{i , m , k} )} \qquad Equation ( 7 )$$

For binary classification, the loss function can be a sigmoid cross entropy function, which can be expressed as below:

$$Equation ( 8 )$$

$$f = - {\sum }_{i = 1}^{N} ( {P}_{ref , i} \times log log ( σ ( {x}_{i} ) ) + ( 1 - {P}_{ref , i} ) \times log ( σ ( {x}_{i} ) ) )$$

$$Where$$

$$σ ( {x}_{i} ) = \frac{1}{1 + {e}^{- {x}_{i}}} ,$$

a sigmoid function and the term xᵢ is the logit or the i-th feature vector. Given the derivative of the sigmoid function with respect to the logit returns σ(xᵢ)×(1−σ(xᵢ)). The training process over the MPC computing systems can be implemented by the following two stages.

At the first stage, the system performs the forward propagation in the training process, each MPC computing system of the multiple MPC computing systems caches the results of the sigmoid function for the feature vector x.

At the second stage, the system begins to perform the backward propagation. The multiple MPC computing systems compute the derivatives of the sigmoid function. i.e., σ(xᵢ)×(1−σ(xᵢ)) using Beaver's triples algorithm. Each MPC computing system can compute the gradients with respect to the coefficients Cₒ and Cₖ, respectively.

In general, the secure processor repeatedly updates the model parameters until reaching a stopping point. The stopping point can include the model parameters satisfy the convergence criteria, reaching a predetermined number of iterations, reaching a predetermined time limit, or other suitable stopping point.

The model parameters can include multiple weights for an output layer of the machine learning model, e.g., coefficients Cₒ and Cₖ. The model parameters can further include a dimension K for embedding vectors, and parameters of the respective lookup table in each computing system of the plurality of MPC computing systems.

To update or refine quantiles, the secure processor can first determine an initial set of buckets based on initial data histogram. The initial set of buckets can be determined via transfer learning (e.g., trained bucket parameters of a pre-trained model). In such cases, the secure processor can compute high-resolution histogram of numerical features for consented user data, and generate the initial set of buckets for users that do not consent the use of particular data based on the high-resolution histogram. In some implementations, the secure processor can estimate the high-resolution histogram via common knowledge (e.g., a human age is generally between 0 to 120) and domain knowledge (e.g., a local temperature is usually between −20 C to 40 C).

Based on the initial set of buckets, the system generates respective secret shares of multiple encoded weight vectors for multiple training feature vectors, and provides the respective secret shares to corresponding computing system of the plurality of MPC computing system to generate respective partial predictions. The secure processor then generates the final predictions based on the respective partial predictions received from the multiple MPC computing systems. These steps are substantially similar to the training steps described above.

After obtaining the final predictions, the secure processor generates an updated data histogram based on the final predictions. More specifically, the secure processor can generate an updated high-resolution histogram and infer an appropriate quantile from the updated histogram. In some cases where the high-resolution histogram is not privacy or security sensitive (e.g., the age distribution at year granularity of a sufficiently large population), the MPC computing systems can reconstruct the updated histogram in cleartext and infer a proper quantile from the cleartext.

The secure processor updates the sequence of fixed knots based on the updated data histogram. The secure processor can repeatedly perform the above-noted steps to update or refine the quantile process until reaching a stopping point. The stopping point can include a condition where the model parameters satisfy the convergence criteria, reaching a pre-determined number of iterations, reaching a pre-determined time limit, or other suitable conditions.

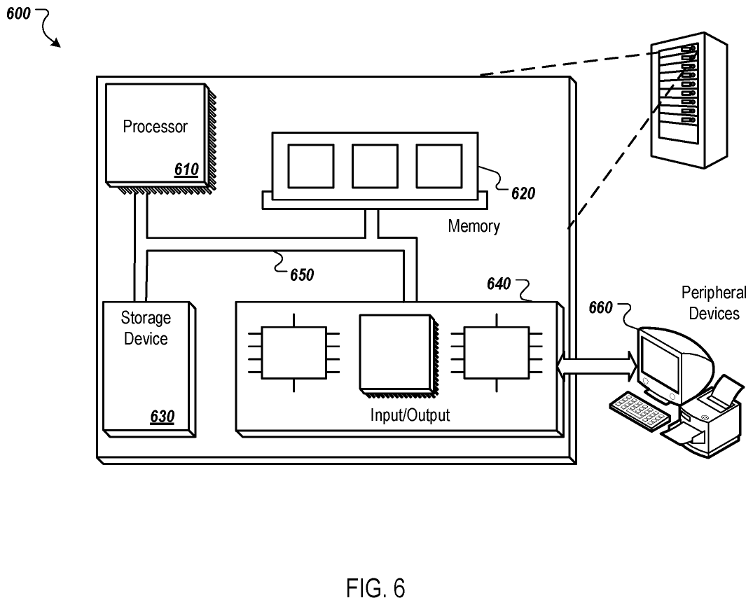

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In some implementations, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In some implementations, the memory 620 is a volatile memory unit. In another implementation, the memory 620 is a non-volatile memory unit.

The storage device 630 is capable of providing mass storage for the system 600. In some implementations, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 400. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition to the embodiments described above, the following embodiments are also innovative:
Embodiment 1 is a method performed by one or more computers, the method comprising: identifying, at a client device, a request for processing an input feature vector by a machine learning model using a multi-party computation (MPC) cluster including a plurality of MPC computing systems, the input feature vector having a sequence of M features; for each feature of the input feature vector, encoding, by the client device, the feature to generate an encoded weight vector according to characteristics of the input feature vector; generating, by the client device for each computing system of the plurality of MPC computing systems, a respective share of the encoded weight vectors; providing, by the client device, each respective share of the encoded weight vector to a corresponding computing system of the plurality of MPC computing systems to generate a respective partial prediction for the respective share; collecting, by the MPC cluster, modified partial predictions for the input feature vector from the plurality of MPC computing systems, where each of the modified partial predications is generated based on the respective partial prediction by a corresponding MPC computing system; and generating, by the MPC cluster, a final prediction for the input feature vector corresponding to the request based on the respective partial predictions.
Embodiment 2 is the method of Embodiment 1, wherein the respective shares of the encoded weight vectors are additive, and the respective shares form the encoded weight vectors encoded from the input feature vector.
Embodiment 3 is the method of Embodiment 1 or 2, wherein generating a respective partial prediction for the respective share comprises: receiving, at a first computing system of the plurality of MPC computing systems, data representing a trained lookup table, wherein the trained lookup table includes a first share of embeddings for corresponding encoded weight vectors; processing the respective share provided to the first computing system using the trained lookup table to generate a partial embedding vector, the partial embedding vector having a sequence of K features; and processing the partial embedding vector to generate a partial prediction for the input feature vector using a trained machine learning model.
Embodiment 4 is the method of any one of Embodiments 1-3, wherein the characteristics of the input feature vector comprise characteristics of each feature in the input feature vector, and where each feature in the input feature vector is a numerical feature or a categorical feature.
Embodiment 5 is the method of Embodiment 3, wherein generating an encoded weight vector according to the characteristics of the input feature vector comprises: if the input feature vector comprises a sequence of categorical features, encoding, for each categorical feature of the sequence of categorical features, the categorical feature using an one-hot vector or distributed point functions to generate the encoded weight vector; and if the input feature vector comprises a sequence of numerical features, encoding, for each numerical feature of the sequence of numerical features, the numerical feature using a four-hot encoding or a three-hot encoding.
Embodiment 6 is the method of Embodiment 5, wherein for each numerical feature located at two ends of the sequence of numerical features included in the input feature vector, encoding the numerical feature using a three-hot encoding.
Embodiment 7 is the method of Embodiment 5 or 6, wherein for each numerical feature located away from two ends of the sequence of numerical features included in the input feature vector, encoding the numerical feature using a four-hot encoding.
Embodiment 8 is the method of any one of Embodiments 1-7, wherein the input feature vector comprises a sequence of numerical features, wherein generating an encoded weight vector according to the characteristics of the input feature vector comprises: determining a sequence of fixed knots for the input feature vector by a quantile process, wherein a number of fixed knots is K+1 and each knot includes a pair of a fixed numerical feature and a fixed embedding for the fixed numerical feature, wherein two neighboring fixed knots form a bucket; allocating a numerical feature of the input feature vector into a corresponding bucket; representing the numerical feature as a weighted sum of three or four fixed embeddings associated with the corresponding bucket; and generating the encoded weight vector based on multiple weight values in the weighted sum.
Embodiment 9 is the method of Embodiment 8, further comprising updating the sequence of fixed knots, comprising: determining an initial set of buckets based on initial data histogram; determining respective shares of multiple encoded weight vectors for multiple input feature vectors; providing the respective shares to corresponding computing system of the plurality of MPC computing system to generate respective partial predictions; generating the final predictions based on the respective partial predictions; generating an updated data histogram based on the final predictions; and updating the sequence of fixed knots based on the updated data histogram.
Embodiment 10 is the method of any one of Embodiments 1-9, wherein generating the final prediction by the MPC cluster for the input feature vector comprises adding, by a particular MPC computing system or a processor of the MPC cluster, the modified partial predictions from the plurality of MPC computing systems.
Embodiment 11 is the method of Embodiment 3, wherein the trained machine learning model comprises: an input layer for receiving input data; a hidden layer for processing the input data to generate embedding for the input data; and an output layer to generate a prediction for the embedding.
Embodiment 12 is the method of Embodiment 11, wherein nodal weights of all nodes in the hidden layer are set to one and remain unchanged during training.
Embodiment 13 is the method of Embodiment 11 or 12, wherein a nodal activation function for each node in the hidden layer is an exponential function.
Embodiment 14 is a system comprising: one or more processors; and one or more storage devices storing instructions that, when executed by the one or more processors, cause the one or more processors to carry out the method of any preceding Embodiment.
Embodiment 15 is a computer readable storage medium carrying instructions that, when executed by one or more processors, cause the one or more processors to carry out the method of any one of Embodiments 1 to 13.
Embodiment 16 is a computer program product comprising instructions which, when executed by a computer, cause the computer to carry out the steps of the method of any of Embodiments 1 to 13.
Embodiment 17 is a computer-implemented method, the method including: receiving a plurality of training feature vectors as training examples, each training feature vector having a sequence of M features; for each training feature vector of the plurality of training feature vectors, generating a final prediction using a machine learning model through a plurality of multi-party computation (MPC) computing systems, comprising: for the training feature vector, generating encoded weight vectors for the training feature vector; each encoded weight vector corresponding to each feature in the training feature vector; generating, for each computing system of the plurality of MPC computing systems, a share of the encoded weight vectors; for each computing system of the plurality of MPC computing systems, providing a corresponding share to the computing system to generate a respective partial prediction for the corresponding share using the machine learning model; generating the final prediction based on the respective partial predictions from the plurality of MPC computing systems; and for each training feature vector of the plurality of training feature vectors, updating model parameters of the machine learning model by reducing a loss determined from a loss function for the final prediction and a reference prediction.
Embodiment 18 is the method of Embodiment 17, wherein the loss function is a Mean-Square-Error (MSE) or a sigmoid cross entropy function.
Embodiment 19 is the method of Embodiment 17 or 18, wherein generating a respective partial prediction for the corresponding share comprises: receiving, at a first computing system of the plurality of MPC computing systems, data representing a respective lookup table, wherein the lookup table includes a first share of embeddings for corresponding encoded weight vectors; processing the corresponding share provided to the first computing system using the lookup table to generate a partial embedding vector, the partial embedding vector having a sequence of K features; and processing the partial embedding vector to generate a partial prediction for the training feature vector using the machine learning model.
Embodiment 20 is the method of Embodiment 19, wherein the model parameters comprise a plurality of weights for an output layer of the machine learning model, a dimension K for embedding vectors, and parameters of the respective lookup table in each computing system of the plurality of MPC computing systems.
Embodiment 21 is the method of any one of Embodiments 17-20, wherein the training feature vector comprises a sequence of numerical features, wherein generating an encoded weight vector comprises: determining a sequence of fixed knots for the training feature vector by a quantile process, wherein a number of fixed knots is K+1 and each knot includes a pair of a fixed numerical feature and a fixed embedding for the fixed numerical feature, wherein two neighboring fixed knots form a bucket; allocating a numerical feature of the training feature vector into a corresponding bucket; representing the numerical feature as a weighted sum of three or four fixed embeddings associated with the corresponding bucket; and generating the encoded weight vector based on multiple weight values in the weighted sum.
Embodiment 22 is the method of Embodiment 21, further comprising updating the sequence of fixed knots, comprising: determining an initial set of buckets based on initial data histogram; determining respective shares of multiple encoded weight vectors for multiple training feature vectors; providing the respective shares to corresponding computing system of the plurality of MPC computing system to generate respective partial predictions; generating the final predictions based on the respective partial predictions; generating an updated data histogram based on the final predictions; and updating the sequence of fixed knots based on the updated data histogram.
Embodiment 23 is the method of any one of Embodiments 17-22, wherein the machine learning model comprises: an input layer for receiving input data; a hidden layer for processing the input data to generate embedding for the input data; and an output layer to generate a prediction for the embedding.
Embodiment 24 is a system comprising: one or more processors; and one or more storage devices storing instructions that, when executed by the one or more processors, cause the one or more processors to carry out the method of any one of Embodiments 17-23.
Embodiment 25 is a computer readable storage medium carrying instructions that, when executed by one or more processors, cause the one or more processors to carry out the method of any one of Embodiments 17 to 23.
Embodiment 26 is a computer program product comprising instructions which, when executed by a computer, cause the computer to carry out the steps of the method of any of Embodiments 17 to 23.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
identifying, at a client device, a request for processing an input feature vector by a machine learning model using a multi-party computation (MPC) cluster including a plurality of MPC computing systems, the input feature vector having a sequence of M features;
for each feature of the input feature vector, encoding, by the client device, the feature to generate an encoded weight vector according to characteristics of the input feature vector;
generating, by the client device for each computing system of the plurality of MPC computing systems, a respective share of the encoded weight vectors;
providing, by the client device, each respective share of the encoded weight vector to a corresponding computing system of the plurality of MPC computing systems to generate a respective partial prediction for the respective share;
collecting, by the MPC cluster, modified partial predictions for the input feature vector from the plurality of MPC computing systems, where each of the modified partial predications is generated based on the respective partial prediction by a corresponding MPC computing system; and
generating, by the MPC cluster, a final prediction for the input feature vector corresponding to the request based on the respective partial predictions.

2. The method of claim 1, wherein the respective shares of the encoded weight vectors are additive, and the respective shares form the encoded weight vectors encoded from the input feature vector.

3. The method of claim 1, wherein generating a respective partial prediction for the respective share comprises:
receiving, at a first computing system of the plurality of MPC computing systems, data representing a trained lookup table, wherein the trained lookup table includes a first share of embeddings for corresponding encoded weight vectors;
processing the respective share provided to the first computing system using the trained lookup table to generate a partial embedding vector, the partial embedding vector having a sequence of K features; and
processing the partial embedding vector to generate a partial prediction for the input feature vector using a trained machine learning model.

4. The method of claim 1, wherein the characteristics of the input feature vector comprise characteristics of each feature in the input feature vector, and where each feature in the input feature vector is a numerical feature or a categorical feature.

5. The method of claim 3, wherein generating an encoded weight vector according to the characteristics of the input feature vector comprises:
if the input feature vector comprises a sequence of categorical features, encoding, for each categorical feature of the sequence of categorical features, the categorical feature using an one-hot vector or distributed point functions to generate the encoded weight vector; and
if the input feature vector comprises a sequence of numerical features, encoding, for each numerical feature of the sequence of numerical features, the numerical feature using a four-hot encoding or a three-hot encoding.

6. The method of claim 5, wherein for each numerical feature located at two ends of the sequence of numerical features included in the input feature vector, encoding the numerical feature using a three-hot encoding.

7. The method of claim 5, wherein for each numerical feature located away from two ends of the sequence of numerical features included in the input feature vector, encoding the numerical feature using a four-hot encoding.

8. The method of claim 1, wherein the input feature vector comprises a sequence of numerical features, wherein generating an encoded weight vector according to the characteristics of the input feature vector comprises:
determining a sequence of fixed knots for the input feature vector by a quantile process, wherein a number of fixed knots is K+1 and each knot includes a pair of a fixed numerical feature and a fixed embedding for the fixed numerical feature, wherein two neighboring fixed knots form a bucket;
allocating a numerical feature of the input feature vector into a corresponding bucket;
representing the numerical feature as a weighted sum of three or four fixed embeddings associated with the corresponding bucket; and
generating the encoded weight vector based on multiple weight values in the weighted sum.

9. The method of claim 8, further comprising updating the sequence of fixed knots, comprising:
determining an initial set of buckets based on initial data histogram;
determining respective shares of multiple encoded weight vectors for multiple input feature vectors;
providing the respective shares to corresponding computing system of the plurality of MPC computing system to generate respective partial predictions;
generating the final predictions based on the respective partial predictions;
generating an updated data histogram based on the final predictions; and
updating the sequence of fixed knots based on the updated data histogram.

10. The method of claim 1, wherein generating the final prediction by the MPC cluster for the input feature vector comprises adding, using a particular MPC computing system or a processor of the MPC cluster, the modified partial predictions from the plurality of MPC computing systems.

11. The method of claim 1, wherein the trained machine learning model comprises:
an input layer for receiving input data;
a hidden layer for processing the input data to generate embedding for the input data; and
an output layer to generate a prediction for the embedding.

12. The method of claim 11, wherein nodal weights of all nodes in the hidden layer are set to one and remain unchanged during training.

13. The method of claim 11, wherein a nodal activation function for each node in the hidden layer is an exponential function.

14. A system comprising:
one or more processors; and
one or more storage devices storing instructions that, when executed by the one or more processors, cause the one or more processors to perform operations comprising:
identifying a request for processing an input feature vector by a machine learning model using a multi-party computation (MPC) cluster including a plurality of MPC computing systems, the input feature vector having a sequence of M features;
for each feature of the input feature vector, encoding the feature to generate an encoded weight vector according to characteristics of the input feature vector:
generating, for each computing system of the plurality of MPC computing systems, a respective share of the encoded weight vectors:
providing each respective share of the encoded weight vector to a corresponding computing system of the plurality of MPC computing systems to generate a respective partial prediction for the respective share;
collecting modified partial predictions for the input feature vector from the plurality of MPC computing systems, where each of the modified partial predications is generated based on the respective partial prediction by a corresponding MPC computing system; and
generating a final prediction for the input feature vector corresponding to the request based on the respective partial predictions.

15. A non-transitory computer readable storage medium carrying instructions that, when executed by one or more processors, cause the one or more processors to perform operations comprising:
identifying a request for processing an input feature vector by a machine learning model using a multi-party computation (MPC) cluster including a plurality of MPC computing systems, the input feature vector having a sequence of M features;
for each feature of the input feature vector, encoding the feature to generate an encoded weight vector according to characteristics of the input feature vector;
generating, for each computing system of the plurality of MPC computing systems, a respective share of the encoded weight vectors;
providing each respective share of the encoded weight vector to a corresponding computing system of the plurality of MPC computing systems to generate a respective partial prediction for the respective share;
collecting modified partial predictions for the input feature vector from the plurality of MPC computing systems, where each of the modified partial predications is generated based on the respective partial prediction by a corresponding MPC computing system; and
generating a final prediction for the input feature vector corresponding to the request based on the respective partial predictions.

16. (canceled)

17. A computer-implemented method comprising:
receiving a plurality of training feature vectors as training examples, each training feature vector having a sequence of M features;
for each training feature vector of the plurality of training feature vectors, generating a final prediction using a machine learning model through a plurality of multi-party computation (MPC) computing systems, comprising: for the training feature vector,
generating encoded weight vectors for the training feature vector; each encoded weight vector corresponding to each feature in the training feature vector;
generating, for each computing system of the plurality of MPC computing systems, a share of the encoded weight vectors;
for each computing system of the plurality of MPC computing systems, providing a corresponding share to the computing system to generate a respective partial prediction for the corresponding share using the machine learning model;
generating the final prediction based on the respective partial predictions from the plurality of MPC computing systems; and
for each training feature vector of the plurality of training feature vectors, updating model parameters of the machine learning model by reducing a loss determined from a loss function for the final prediction and a reference prediction.

18. The method of claim 17, wherein the loss function is a Mean-Square-Error (MSE) or a sigmoid cross entropy function.

19. The method of claim 17, wherein generating a respective partial prediction for the corresponding share comprises:
receiving, at a first computing system of the plurality of MPC computing systems, data representing a respective lookup table, wherein the lookup table includes a first share of embeddings for corresponding encoded weight vectors;
processing the corresponding share provided to the first computing system using the lookup table to generate a partial embedding vector, the partial embedding vector having a sequence of K features; and
processing the partial embedding vector to generate a partial prediction for the training feature vector using the machine learning model.

20. The method of claim 19, wherein the model parameters comprise a plurality of weights for an output layer of the machine learning model, a dimension K for embedding vectors, and parameters of the respective lookup table in each computing system of the plurality of MPC computing systems.

21. The method of any one of claim 17, wherein the training feature vector comprises a sequence of numerical features, wherein generating an encoded weight vector comprises:
determining a sequence of fixed knots for the training feature vector by a quantile process, wherein a number of fixed knots is K+1 and each knot includes a pair of a fixed numerical feature and a fixed embedding for the fixed numerical feature, wherein two neighboring fixed knots form a bucket;
allocating a numerical feature of the training feature vector into a corresponding bucket;
representing the numerical feature as a weighted sum of three or four fixed embeddings associated with the corresponding bucket; and
generating the encoded weight vector based on multiple weight values in the weighted sum.

22. The method of claim 21, further comprising updating the sequence of fixed knots, comprising:
determining an initial set of buckets based on initial data histogram;
determining respective shares of multiple encoded weight vectors for multiple training feature vectors;
providing the respective shares to corresponding computing system of the plurality of MPC computing system to generate respective partial predictions;
generating the final predictions based on the respective partial predictions;
generating an updated data histogram based on the final predictions; and
updating the sequence of fixed knots based on the updated data histogram.

23. The method of any one of claim 17, wherein the machine learning model comprises:
an input layer for receiving input data;
a hidden layer for processing the input data to generate embedding for the input data; and
an output layer to generate a prediction for the embedding.

24. (canceled)

25. (canceled)

26. (canceled)
